(19) United States
(12) Patent Application Publication
(10) Pub. No.: US 2005/0199293 A1
(43) Pub. Date: Sep. 15, 2005

(54) Manifold for selectively dispersing multiple fluid streams

(76) Inventors: Robert A. Fulcher, Grand Junction, CO (US); Allan E. Beavers, Grand Junction, CO (US)

Correspondence Address: SHERIDAN ROSS PC, 1560 BROADWAY, SUITE 1200, DENVER, CO, 80202, US

(21) Appl. No.: 11/054,923

(22) Filed: Feb. 9, 2005

Related U.S. Application Data
(60) Provisional application No. 60/544,544, filed on Feb. 12, 2004.

(51) Int. Cl. F16K 51/00

(52) U.S. Cl. 137/561 A

(57) ABSTRACT

The present invention relates generally to manifolds adapted to receive a fluid stream from one location and distribute it to a plurality of different locations. More specifically, one embodiment of the present invention includes an in-line, generally cylindrical, manifold adapted to receive high volumes of fluid and distribute it to a plurality of discharge nozzles. It is envisioned that these smaller volume discharge nozzles would be interconnected to hoses, wherein the fluid is transported to various locations for a preferred use. For example, in one embodiment of the present invention, the manifold would be used to transport treated water to various decontamination units to treat victims of chemical, biological, or nuclear attacks.

### CROSS REFERENCE TO RELATED APPLICATIONS

This application claims the benefit of U.S. Provisional Patent application Ser. No. 60/544,544, filed Feb. 12, 2004, which is incorporated by reference in its entirety herein.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to an apparatus that receives fluid at one location and disperses at least one fluid stream from a second location. More specifically, one embodiment of the present invention receives fluid at an inlet, redistributes the fluid through a plurality of selectively openable outlets, and expels the fluid through a discharge outlet.

### BACKGROUND OF THE INVENTION

Manifolds, which are devices adapted to receive a fluid and redistribute it to at least one additional location, are well known, especially in industrial applications. Generally, these devices divide a large volume of fluid into smaller more manageable fluid streams in order to distribute the fluid to a plurality of locations. For example, these devices may be used to distribute potable water at a disaster site or to selectively direct oil or gas in a refinery or other similar setting. Additional uses for the present invention are easily appreciated in the arena of homeland security, wherein, manifolds may be used to selectively distribute streams of treated fluid adapted to neutralize chemical, nuclear, or biological agents.

One drawback of manifolds commonly used is their material of construction. Generally, manifolds are constructed from galvanized steel or poly-vinyl chloride (PVC) pipe. In addition, the fittings employed on many manifolds are not suited for high pressure operations, and are thus prone to leakage. Further, galvanized pipe will oxidize if its protective zinc coating is removed or altered from scratches or gouges resulting from rough usage. Further, many manifolds are used in non-ideal environments that put them at risk of damage and/or oxidation that may make the manifold susceptible to structural failure. The other common manifold material, PVC pipe, is brittle and is thus prone to cracking.

Another drawback is that many manifolds employ a closed end. More specifically, some manifolds include one inlet and a plurality of smaller outlets only. By using a closed end, outlet pressures are higher, but providing large mass flows subsequent to the manifold is not possible. That is, a series combination of hose to manifold to hose, etc. is not possible. Thus, the large, high pressure, mass flow entering the inlet is cut off and smaller lines are relied upon to distribute the fluid. If a large mass flow of fluid is needed in another area, additional hoses originating from a main fluid source are required that are often time consuming to connect.

The following disclosure describes an improved manifold that is adapted to receive at least one fluid and selectively distribute a plurality of fluid streams, and which includes an outlet that is adapted for interconnection with subsequent fluid delivery means, such that a plurality of manifolds may be effectually linked in series to more efficiently serve a large number of individuals.

### SUMMARY OF THE INVENTION

It is thus one aspect of the present invention to provide a manifold that is adapted to receive at least one fluid source and distribute it through a plurality of outlets. More specifically, one embodiment of the present invention employs an inlet that is adapted to receive various types of fluid interfaces, such as a threaded coupler, a quick connect/disconnect, a snap fit, or a biased-fit mechanism. Hence, a manifold body is provided, such as a cylinder, which is adapted to hold fluid and provide locations for at least one outlet. Preferably, the outlet is in fluid communication with a mechanism that selectively controls the mass flow of the exiting fluid, such as a valve or nozzle. Alternatively, or in conjunction with the flow control device, an interfacing means, such as threads or a quick connect/disconnect mechanism, is incorporated on the outlet to allow for selective interconnection to a fluid distribution device, such as a hose. The outlet hose interconnections are preferably easy to interconnect, thereby reducing the time required for system implementation. In addition, as will be appreciated by one skilled in the art, the manifold of the present invention may be scaled to any size. However, it is envisioned that a plurality of outlets are provided that are smaller than the inlet, such that a plurality of pressurized fluid streams emanate from the manifold body.

It is another aspect of the present invention that the fluid outlets be oriented in any location on the manifold, are designed to accommodate a variety of mass flow rates, and can be in any number or sequence. More specifically, a substantially cylindrical manifold body may be provided such that outlets are located in any number, and in any orientation. Another embodiment employs equally-spaced outlets on either side of the manifold body that deploy fluid in opposite directions.

It is a related aspect of the present invention to provide a discharge outlet, wherein one or more subsequent manifolds may be linked in fluidic communication. Preferably, one embodiment of the present invention includes a discharge outlet interconnected to the manifold body that is adapted to selectively interconnect with a fluid distribution device, such as a hose. The discharge outlet is preferably substantially similar and in-line with the inlet. Closure of the flow control devices interconnected to the smaller outlets incorporated into the manifold body defines a substantially straight, branchless, flow path for the fluid. Alternatively, a split manifold may be provided, wherein one inlet and at least two discharge outlets are employed that have either the same diameter as the inlet, or a reduced diameter.

It is another aspect of the present invention to provide an interconnection device on at least one of the inlet and the discharge outlet of the manifold. More specifically, a threaded interface may be provided wherein various adapters are employed. One adapter includes threads that allow for the selective interconnection with threads machined into an inner diameter of the inlet or discharge outlet. The adapter may also receive various other adapters or a cap that creates a flow path dead-end. For example, one configuration includes a swivel connector that is operably interconnected to the adapter and a hose. Alternatively, a device that alters the diameter of the input or the discharge outlet flow path may be interconnected to the adapter. For example, a reducer/expander adapter may be employed such that a smaller input or output diameter hose may be attached to a larger diameter manifold body. As will be appreciated by one skilled in the art, although only threaded interfaces have been described thus far, other interconnection devices located between the inlet and/or discharge outlet and the adaption device, or between the adaption device and any selective interconnection device, may be employed to without departing from the scope of the invention. For example, a quick connect/disconnect mechanism, an interference fit, a compression clamp, etc., may be used to achieve similar results. Alternatively, adapters or interconnection mechanisms may be integrally machined into one or both of their adjacent components, as will be apparent to one skilled in the art.

It is a further aspect of the present invention to provide a manifold that can be elevated a predetermined distance from a generally planar surface. Preferably, in one embodiment of the present invention, one or more removable brackets or clamps are attached to the manifold, wherein hoses are quickly and easily interconnected thereto without increasing the probability of hand injury. The brackets are adapted to cradle the manifold body and are interconnected thereto using screws, adhesives, bolts, welds, hinges, buckles, grommets, clamps etc. The bracket may additionally include apertures, or other devices, adapted to provide a location for selective interconnection with a substantially flat object, such as a wood plank or concrete slab. Alternatively, the manifold may be used without support devices, on perhaps uneven ground where such features may become a hindrance. In addition, support may not be needed when a plurality of manifolds are directly connected to each other. More specifically, it is envisioned that adapters may be utilized that allow for direct manifold-to-manifold connection without the requirement of a hose therebetween. In this configuration selectively interconnecting support devices may be placed in order to provide the most efficient structural stability. Finally, the support devices may be adapted to be used to store the manifold when not in use.

It is yet another aspect of the present invention to provide a manifold that is constructed from a material that is strong and resistant to degradation from corrosion or foreign objects such as chemical compounds. Ideally, a high modulus material that is capable of limited elastic deformation is employed that withstands high stresses, and thus is capable of transporting fluids under high pressure. Preferably, one embodiment of the present invention is constructed of an aluminum alloy, such as AL 6061-T6. However, other corrosion resistant materials known in the art may be employed, for example stainless steel, inconel, brass, plastic, magnesium, or titanium. One skilled in the art will appreciate that various manufacturing methods, such as casting, machining, forging, stamping, or a combination thereof, may be used to form the manifold without departing from the scope of the invention. Moreover, factors such as the environment of use, conveyed fluid, vibrational dynamics, the method of manufacture, cost, etc., will have to be assessed prior to any material selection. A related aspect of the present invention is that it be easily repaired, wherein damaged components may be patched, re-threaded, welded, brazed or otherwise repaired or replaced.

It is still yet an aspect of the present invention to provide a manifold that is adapted for use in a variety of fields and situations. More specifically, the present invention may be employed at disaster areas to provide potable water to the victims, at locations exposed to biological, chemical, or nuclear contamination to aid in the decontamination of individuals or property, in agriculture to aid in irrigation and pesticide and/or herbicide applications. Alternatively, the apparatus may be used in recreational applications to provide water and other treatments to golf courses and athletic fields, in amusement and water parks, in environmental applications such as oil clean up, in fire fighting, in hospitals, and in military and civilian fueling operations. The possibilities are limitless where a single fluid stream is required to be split into many steams, and where two manifolds are interconnected in series or parallel. Alternatively, the flow may be reversed such that many small streams are converted into a large one, such in waste disposal. One use that is of note, due to the current geopolitical environment, and of great interest to homeland security and the military, is that of chemical, biological, and nuclear contamination removal. The present invention is adapted to allow for quick deployment of a plurality of cleaning stations and/or showers, wherein many individuals may be efficiently treated. More specifically, a single fluid source, generally treated with a counter agent, may be distributed via manifolds and hoses to a plurality of decontamination locations, thereby alleviating the need to mix and pump multiple sources of treated fluid.

Thus, it is one aspect of the present invention to provide a fluid manifold that comprises:
a body, having a first end and a second end, said body having a internal diameter which defines a flowpath;
an inlet interconnected to said first end of said body, which is adapted to operably interconnect with a first fluid delivery device that transports fluid from a first location;
at least one outlet interconnected to said body between said first end and said second end, which is adapted to selectively distribute the fluid to a second location via a second fluid delivery device; and
a discharge outlet interconnected to said second end of said body, which is adapted either to operably interconnect with a cap, or to a third fluid transportation device that transports the fluid to a third location, such that a plurality of said fluid manifolds may be operably interconnected.

The Summary of the Invention is neither intended nor should it be construed as being representative of the full extent and scope of the present invention. The present invention is set forth in various levels of detail in the Summary of the Invention as well as in the attached Figures and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 are views of a six-outlet embodiment of the present invention;

FIG. 2 are views of a manifold body employed by the embodiment shown in FIG. 1;

FIG. 3 are views of a bracket employed in one embodiment of the present invention;

FIG. 4 are views of a clamp employed in one embodiment of the present invention;

FIG. 5 are views of an outlet adapter employed in one embodiment of the present invention;

FIG. 6 are views of an adapter employed in one embodiment of the present invention;

FIG. 7 is a partial section view of a cap employed in one embodiment of the present invention;

FIG. 8 are views of a swivel fitting employed in one embodiment of the present invention;

FIG. 9 are views of a swivel fitting adapter employed in one embodiment of the present invention;

FIG. 10 are views of a plug used to retain ball bearings employed by swivel fittings of one embodiment of the present invention;

FIG. 11 is a partial section view of a reducer/expander adapter employed by one embodiment of the present invention;

FIG. 12 is a partial section view of another adapter employed by one embodiment of the present invention;

FIG. 13 is a right elevation view of an adapter and swivel fitting assembly employed by one embodiment of the present invention;

FIG. 14 are views of the adapter shown in FIG. 13;

FIG. 15 is a partial section view of swivel connector employed by one embodiment of the present invention;

FIG. 16 are views of a piston ring used in conjunction with the swivel connector shown in FIG. 15;

FIG. 17 are views of seals employed in various embodiments of the present invention;

FIG. 18 are views of an alternative, two-outlet, embodiment of the present invention;

FIG. 19 are views of a manifold body employed by the embodiment shown in FIG. 18; and

FIG. 20 is a schematic showing a plurality of deployed manifolds.

To assist in the understanding of the present invention the following list of components and associated numbering found in the drawings is provided herein:

| Component | # |
|---|---|
| In-Line Manifold | 2 |
| Manifold Body | 4 |
| Outlet | 5 |
| Bracket | 6 |
| Clamp | 8 |
| Outlet Adapter | 10 |
| Adapter | 14 |
| Cap | 16 |
| Swivel Adapter | 30 |
| Swivel | 38 |
| Discharge Outlet | 40 |
| Inlet | 42 |
| Groove | 44 |
| Ball Bearing Hole | 46 |
| Plug | 48 |
| Neck-down adapter | 50 |
| Channel | 52 |
| Piston Ring | 54 |
| Aperture | 56 |
| Fire hose | 58 |
| Feed line | 60 |
| Valve | 62 |
| Connector | 64 |
| Outlet cap | 66 |
| Hydrant | 68 |
| Solution | 70 |
| Pump | 72 |
| Shower | 74 |
| Shower hoop | 76 |

It should be understood that the drawings are not necessarily to scale. In certain instances, details that not necessary for an understanding of the invention or which render other details difficult to perceive may have been omitted. It should be understood, of course, that the invention is not necessarily limited to the particular embodiments illustrated herein.

### DETAILED DESCRIPTION

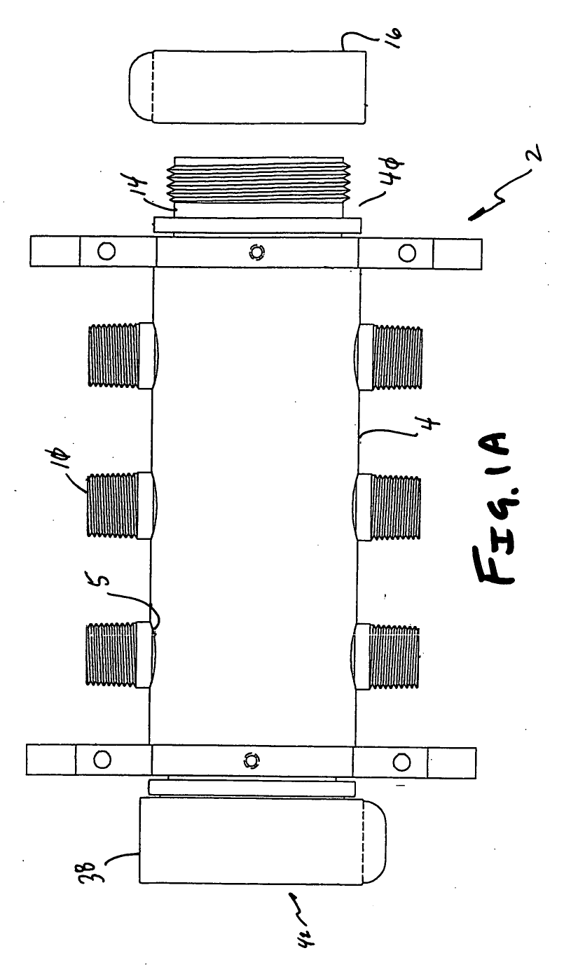

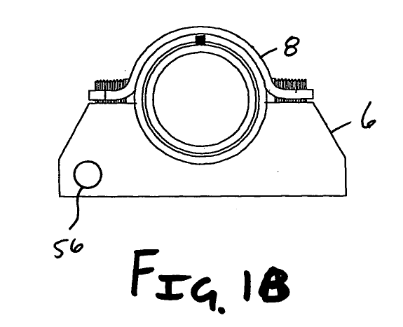

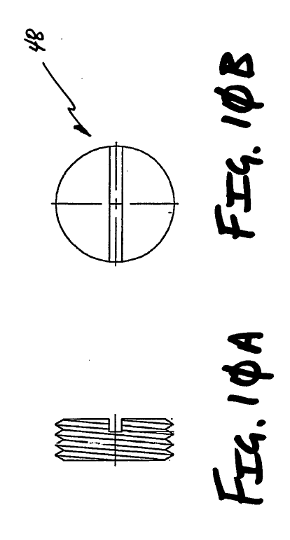

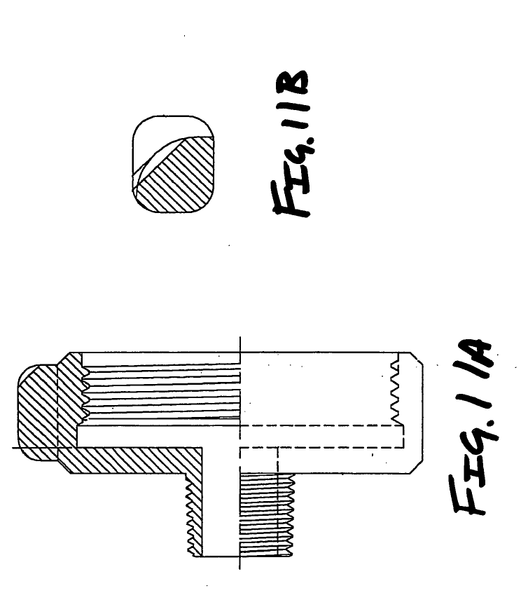

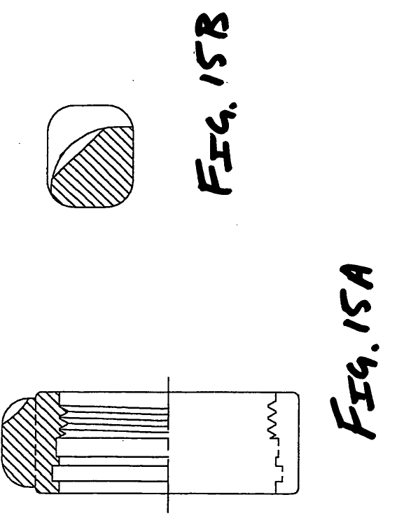

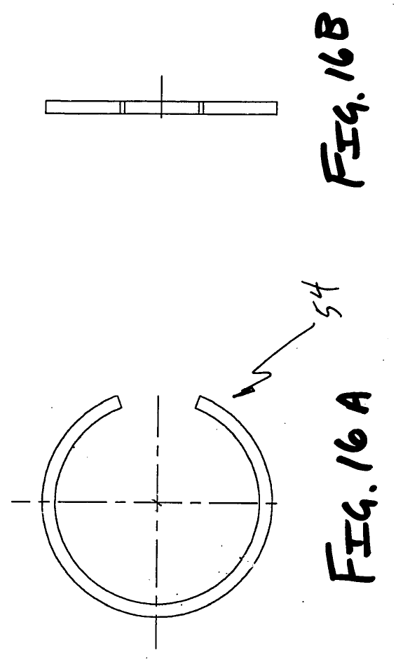

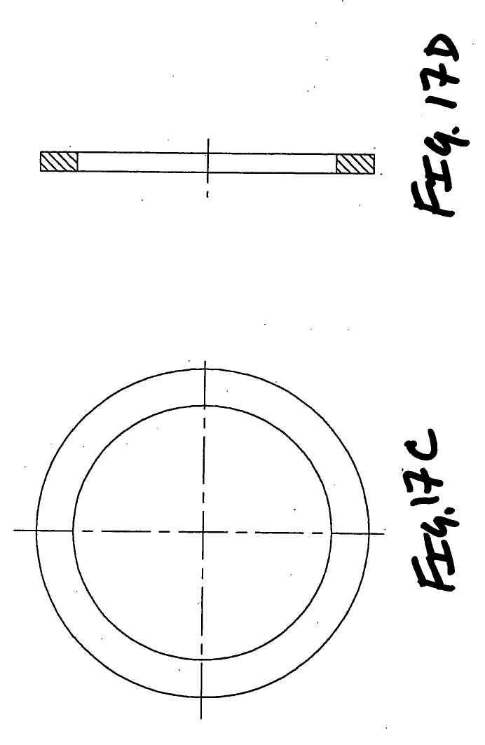

Referring now to FIGS. 1-17, one embodiment of the present invention is provided. More specifically, and referring to FIG. 1, an in-line manifold 2 is depicted that includes a manifold body 4, at least one bracket 6, at least one clamp 8, at least one outlet 5, an adapter 14, 30, a discharge outlet 40, an inlet 42, and various interconnecting devices adapted to interface with the adapter 16, 38. In general, the present invention is adapted to receive fluid from a fluid source, such as a fire hose, and distribute it through a plurality of smaller outlets 5. In addition, the larger discharge outlet 40 may also be interconnected to another fluid delivery device, such as a hose, thereby allowing connections to other manifolds 2 of the present invention.

Referring now to FIG. 1, one embodiment of the present invention is shown. More specifically, an in-line manifold 2 is shown that employs an inlet 42 and a discharge outlet 40, wherein a plurality of smaller outlets 5 are positioned therebetween. Preferably, this embodiment of the present invention also includes brackets 6 and clamps 8 that secure the manifold body 4 in place and that allow for positioning on a planar surface, for example. The manifold body 4 is adapted to selectively interconnect to adapters 14 and 30 at the inlet 42 and at the discharge outlet 40, preferably by a threaded connection, but other connections known to those skilled in the art such as a quick connect/disconnect, weld, a snap-fit, or a biased-fit connector may be employed as well. Smaller outlets 5 on the manifold body 4 are also equipped with threads, wherein outlet adapters 10 may be selectively interconnected. Alternatively, the outlet adapters may be welded, braised, or otherwise rigidly interconnected to the manifold body 4. It is envisioned that the outlet adapters 40 will provide an interconnection location for nozzles, valves, or any other device used for flow control. The adapters on the inlet 42 and outlets 5, 42 of the present invention are also capable of receiving various other adapters. For example, in one embodiment of the present invention, a cap is employed, wherein the manifold 2 terminates at a closed end. In an alternative embodiment, a swivel adapter 38 is incorporated onto the inlet adapter 30 or the outlet adapter 14 to provide a location where a hose may be interconnected. Other adapters well known in the art may also be used, for example a reducer/expander adapter, wherein a smaller inlet hose may be used to interface with a larger manifold body 4. Other adapters will become apparent to one skilled in the art upon further review of this specification.

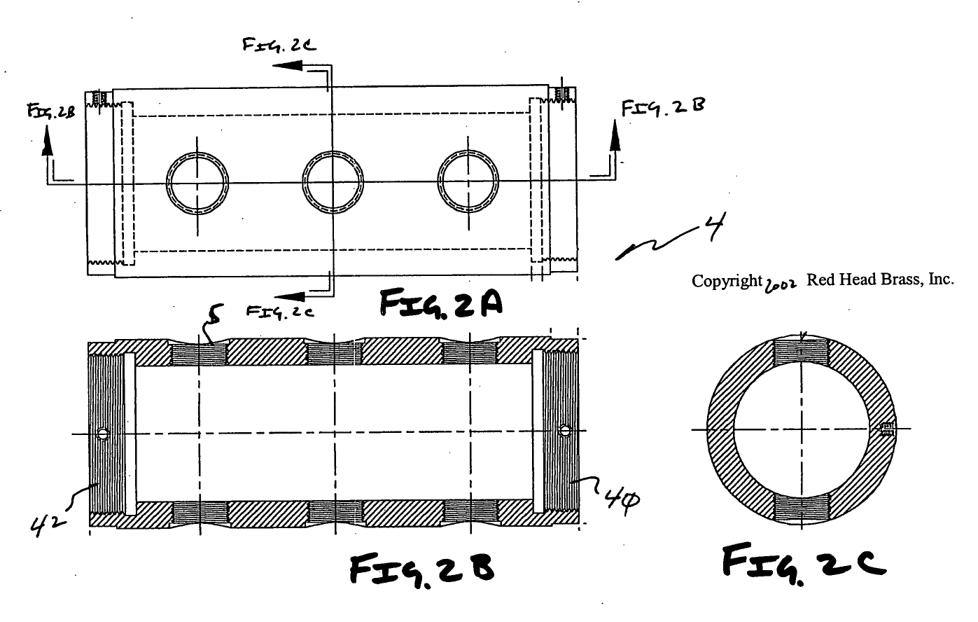

Referring now to FIG. 2, the manifold body 4 of one embodiment of the present invention is shown herein. The manifold body 4 is generally constructed from a cylindrical pipe. Preferably the material is corrosion resistant, such as aluminum, and more preferably aluminum 6061-T6. The cylinder is then machined with a plurality of threaded interfaces. One skilled in the art will appreciate that the manifold body 4 may have substantially any size to accommodate any fluid inlet device. In addition, in one embodiment of the present invention the outlets 5 are located approximately 180 degrees from each other. It is envisioned that the threads on the inlet 42 and discharge outlet 40 portions of the manifold body will be capable of accommodating adapters, and the outlet 5 threads will be machined to accommodate smaller adapters that may selectively interconnect to flow control mechanisms.

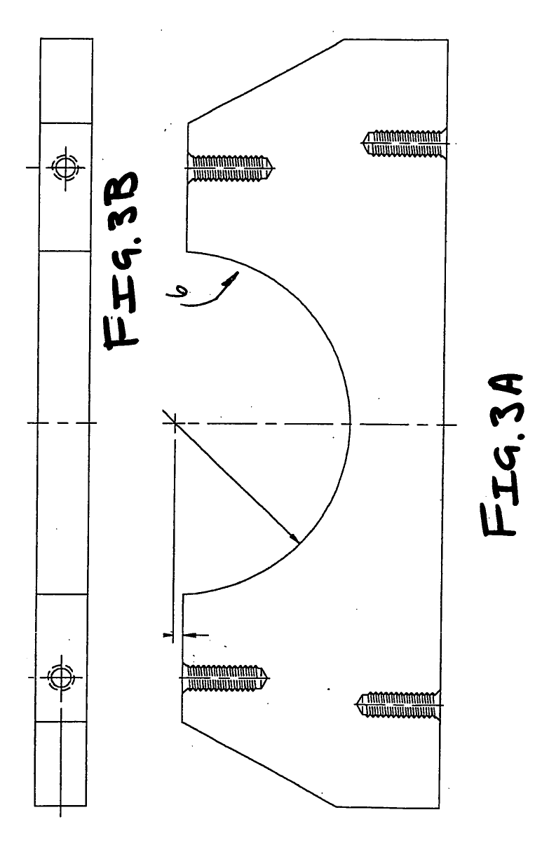

Referring now to FIG. 3, the bracket 6 of one embodiment of the present invention is shown. The bracket is preferably adapted to interface with the cylindrical manifold body and the clamp to provide a support. In addition, the bracket is preferably employed with a plurality of threaded holes wherein screws or other interconnection devices may be used to selectively interconnect the clamp to the manifold body. It is important to note however, that the manifold of the present invention does not require the use of such brackets 6. The bracket may also include an aperture 56 that provides a location for a tie or a clip. More specifically, the apertures 56 or other similar device allows the manifold to be easily carried on a fireman's belt.

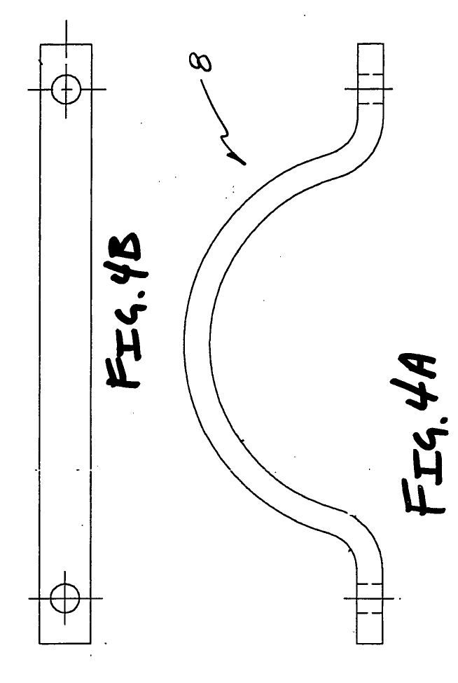

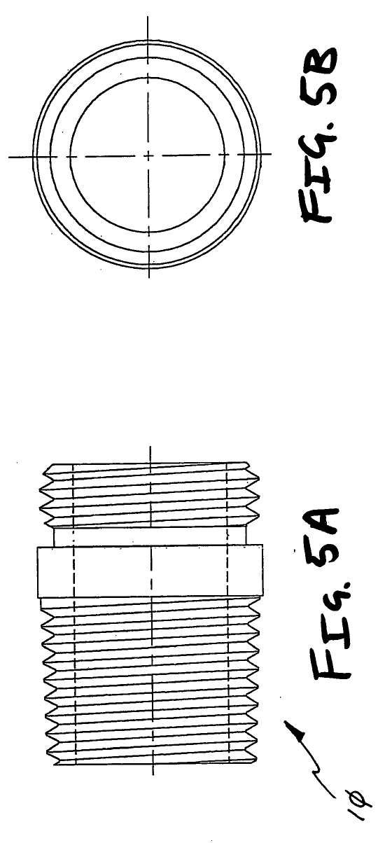

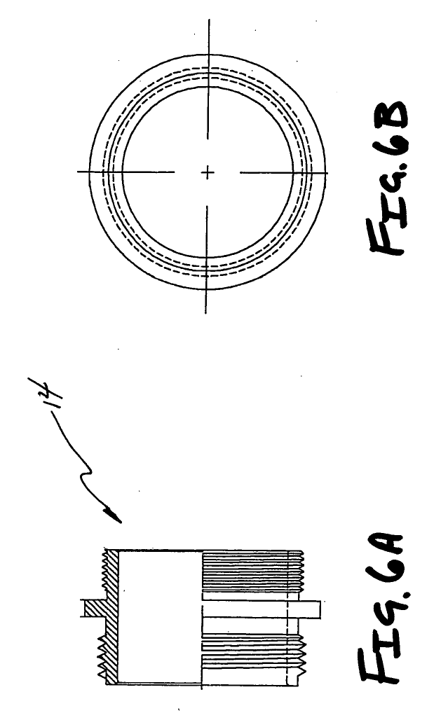

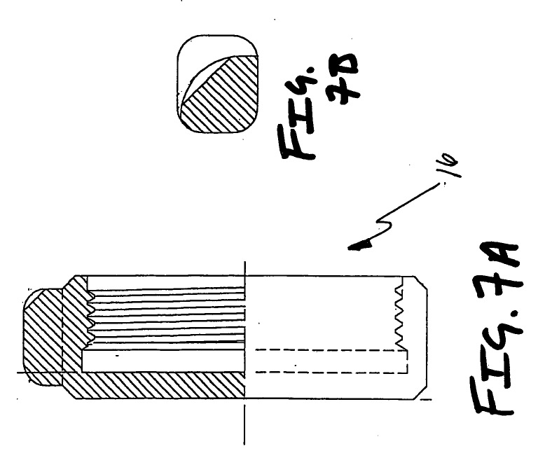

Referring now to FIG. 4, the clamp 8 of the present invention is shown. The clamp 8 used in conjunction with the aforementioned bracket, wherein an interconnection device is used to fasten the clamp 8 around the manifold. In addition, it is envisioned that the clamp 8 and its mating bracket may be selectively interconnected to allow the user to have a wide variety of supporting options.

Referring now to FIG. 5, an outlet adapter 10 is shown. In one embodiment of the present invention, the smaller outlets of the manifold body are machined to receive an adapter 10. This adapter 10 is also capable of receiving a flow control device such as a ball valve, a check valve, a regulator valve, or any other device for selectively controlling the flow of fluid through an orifice. One skilled in the art will appreciate that although threaded interconnections are shown herein, they are not necessarily required. For example, quick connect/disconnect, snap-fit, and biased-fit connectors, or any other means to fasten a water delivery device, such as a hose, to an outlet may be employed. The materials of the outlet adapters 10 are preferably not corrosively reactive with the manifold body, thus aluminum 6061-T6 is preferably used. In addition, it is envisioned that the adapters 10 be easily interconnected such that repair or replacement is done more efficiently. Alternatively, if repair is not a concern, one can easily weld the outlets 10 onto the manifold body to create a more permanent and stable interface.

Referring now to FIG. 6, an inlet/discharge outlet adapter 14 is shown. One embodiment of an adapter employed in the present invention includes at least two sets of threaded interfaces, wherein one is selectively interconnected to the manifold body, and the other set is selectively interconnected to a cap, for example. The material of the adapter 14, again should be non-reactive with the material of the manifold body, preferably aluminum 6061-T6. However, other materials may be employed to achieve the same result, such as plastic. In addition, one skilled in the art will appreciate that although a threaded interconnection means is shown herein, other interconnection means may be employed to achieve the same result. Alternatively, it should be appreciated that only one set of threads, to engage a cap for example, may be needed, wherein the manifold body may have external threads machined thereon wherein said swivel connector or cap may be selectively interconnected.

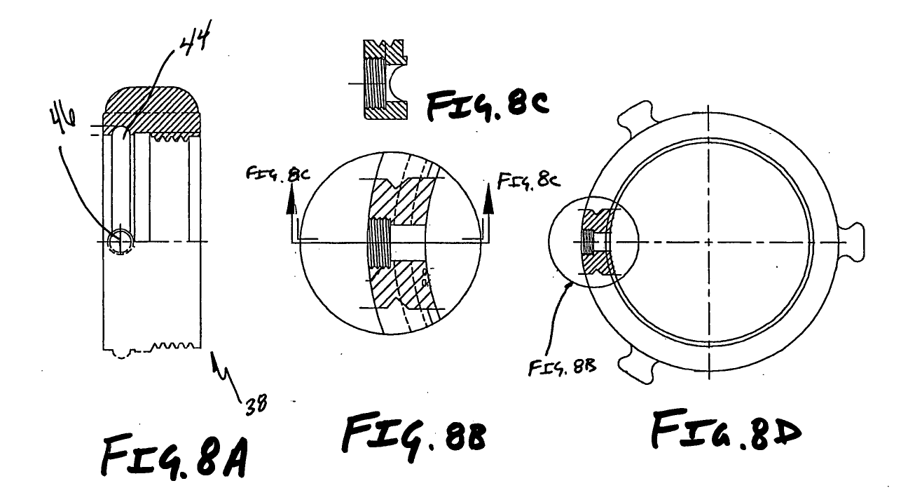

Referring now to FIG. 7, the cap 16 of one embodiment of the present invention is shown herein. The cap 16 preferably employs inner threads that selectively interconnect with external threads on the previously-mentioned adapter. When the cap is employed, the present invention has a closed end, wherein fluid enters from the inlet side and disperses selectively through the smaller outlets integrated into the manifold body. In addition, caps 16 may be employed on both ends of the manifold wherein a small fluid source would be interconnected to one of the smaller outlets and dispersed through the remaining outlets.

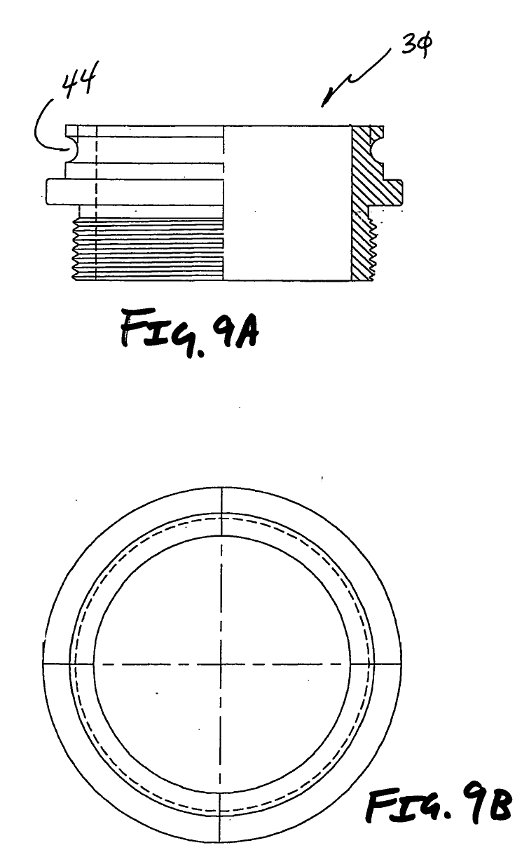

Referring now to FIGS. 8-10, a swivel connector 38 of one embodiment of the present invention is shown. The swivel connector 38 is used for selective interconnection with a fluid input line, such as a fire hose. Preferably, the hose is threaded on the outside diameter and the swiveling portion of the sub-system is threaded on the inside diameter. In this embodiment of the present invention, it is envisioned that the swivel connector adapter 30 will be utilized on at least one end of the manifold body, wherein exterior threads on the adapter 30 would selectively interconnect with the interior threads of the manifold body. This adapter 30 also employs a generally spherical groove 44. To interconnect the swiveling portion 38 to the adapter portion 30 the grooves 44 of each portion would be placed adjacent to each other. Ball bearings are subsequently dropped through a hole 46 that is integrated into the swiveling portion 38 of the interface, thereby substantially filling the groove 44. Once the ball bearings are in place, a plug 48 would be inserted and secured into the hole 46. The resulting sub-system is easily rotated, thus facilitating hose interconnection.

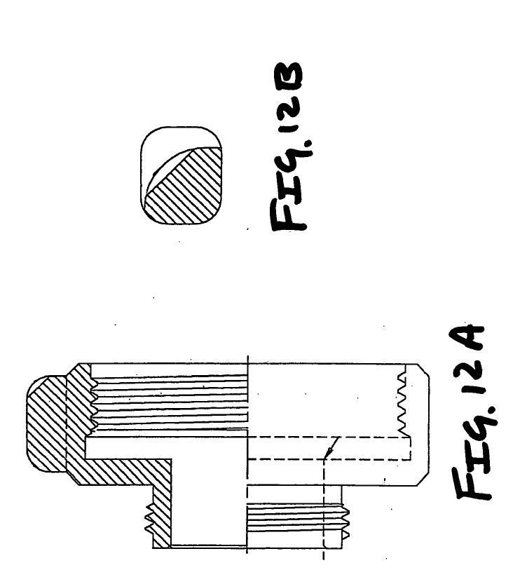

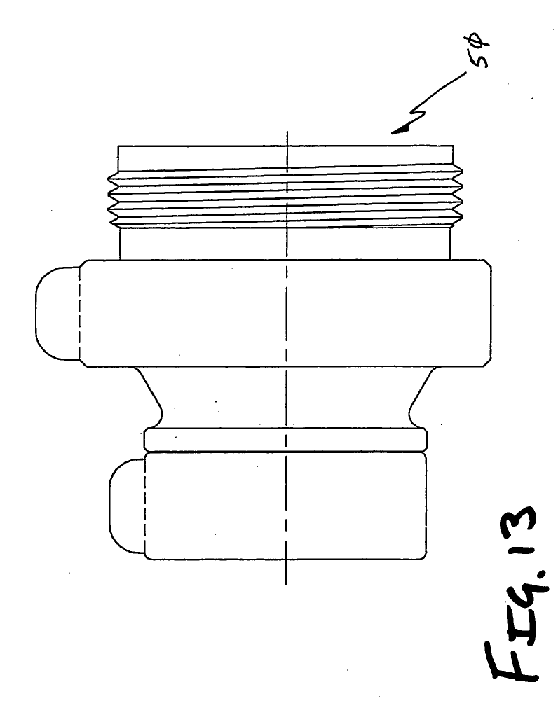

Referring now to FIGS. 11 and 12, another type of adapter used in one embodiment of the present invention is shown. This adapter is designed to be used with water delivery devices, such as hoses, that have a smaller diameter than that of the manifold body. In addition, the adapters are generally constructed of a small inlet with external threads, for selective interconnection to a hose, and a larger outlet with internal threads that are adapted to interface with the threads of the adapter shown in FIG. 6.

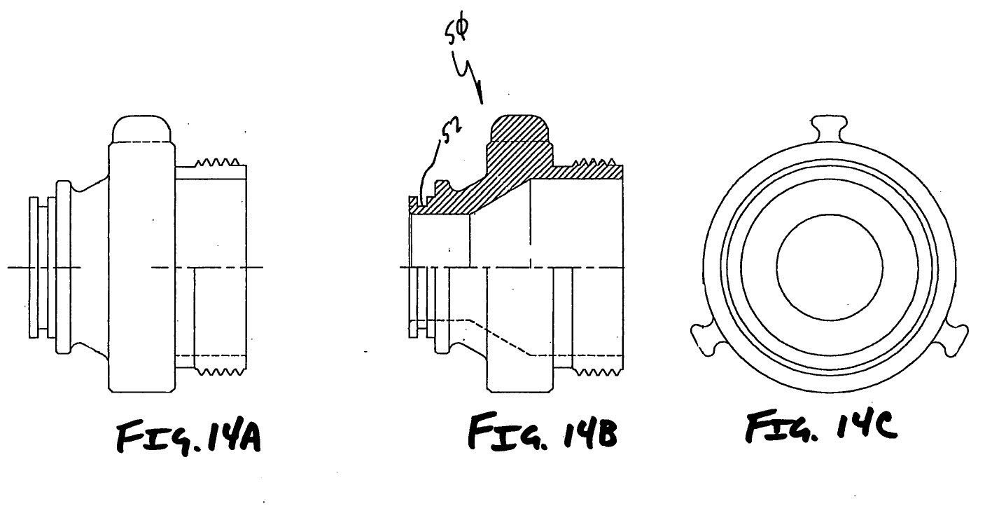

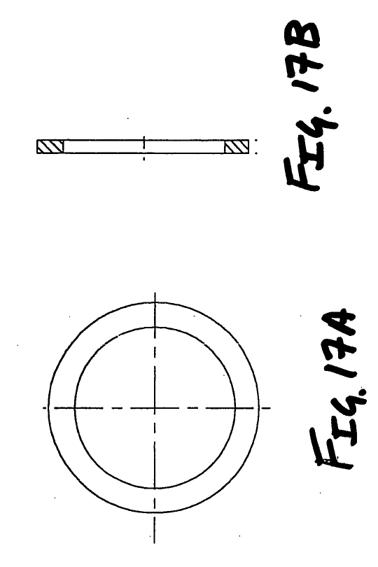

Referring now to FIGS. 13-16 another type of reducer/expander adapter 50 that is capable of swiveling is shown. A portion of the sub-system 50 also includes a small channel 52 that receives an aluminum piston ring 54. Once the ring 54 is in place, the swiveling portion, as shown in FIG. 15, is selectively interconnected thereto. The resulting sub-system 50 is capable of interfacing with the manifold body, and a water delivery device, similar to the swivel connection described above.

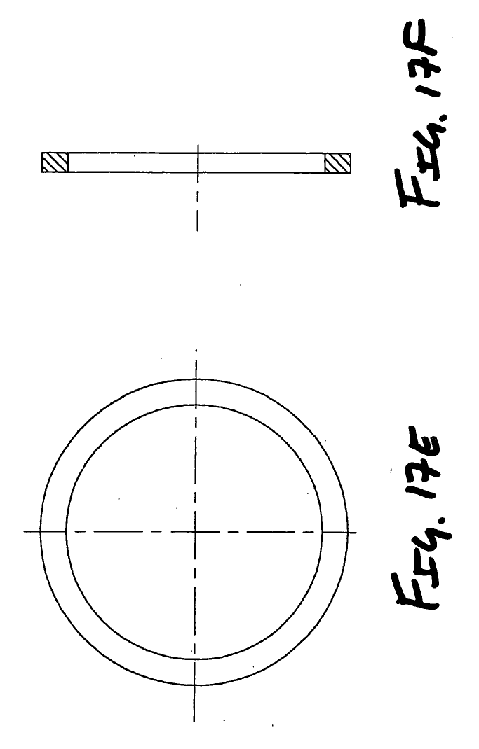

Referring now to FIG. 17, seals used in various embodiments of the present invention are shown. Since the system is generally used to carry fluid and/or gas, it is desirable to maintain pressure therein and prevent leakage thereof. In order to accomplish this task, various types of seals and gaskets are used to maintain pressure and prevent leakage of the system. Many materials for these gaskets and seals may be used such as rubber, plastic, aluminum, or any other material that is adapted to prevent leakage.

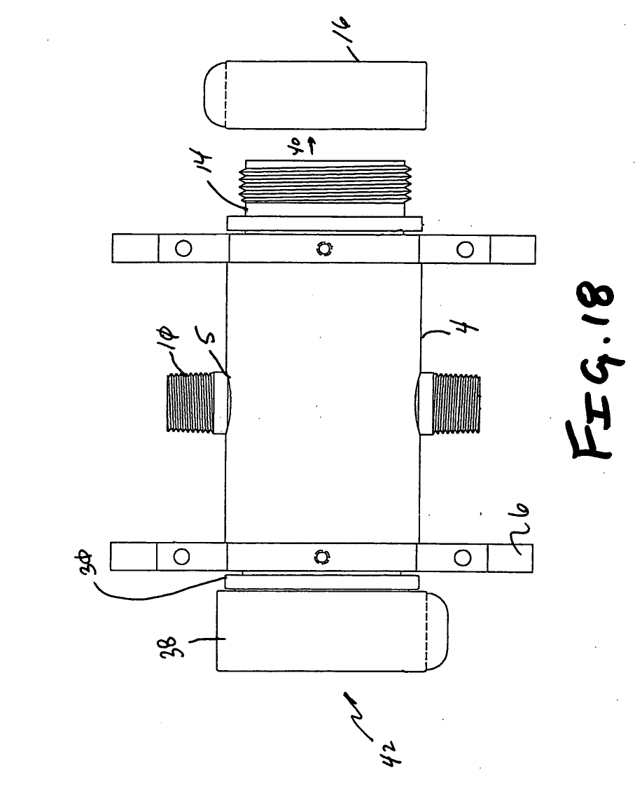

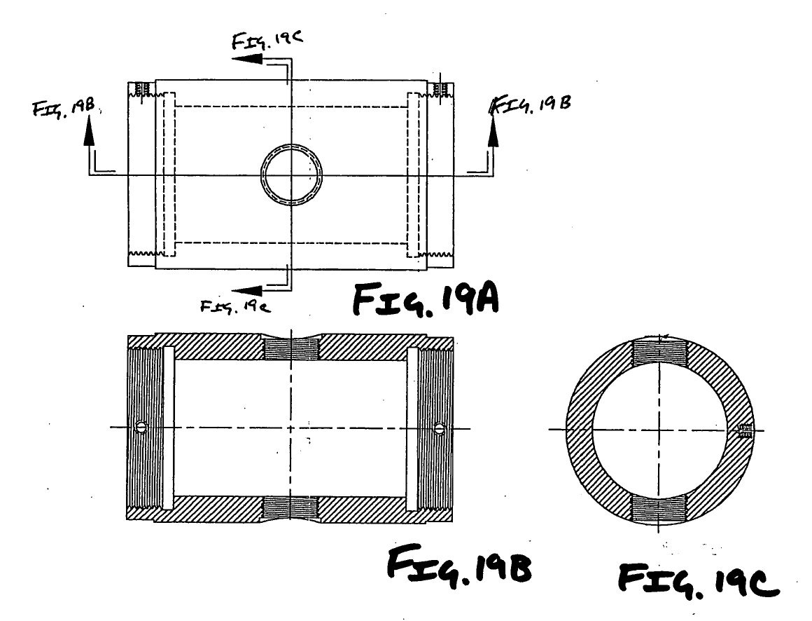

Referring now to FIGS. 18 and 19, another embodiment of the present invention is shown. More specifically, the present invention may be adapted to employ any number of small outlets 5. In addition, as would be appreciated by one skilled in the art, any radial placement on the manifold body may be used to achieve similar results. For example, outlets 5 may be situated pointing up, down or at any angle relative to a horizontal or vertical plane.

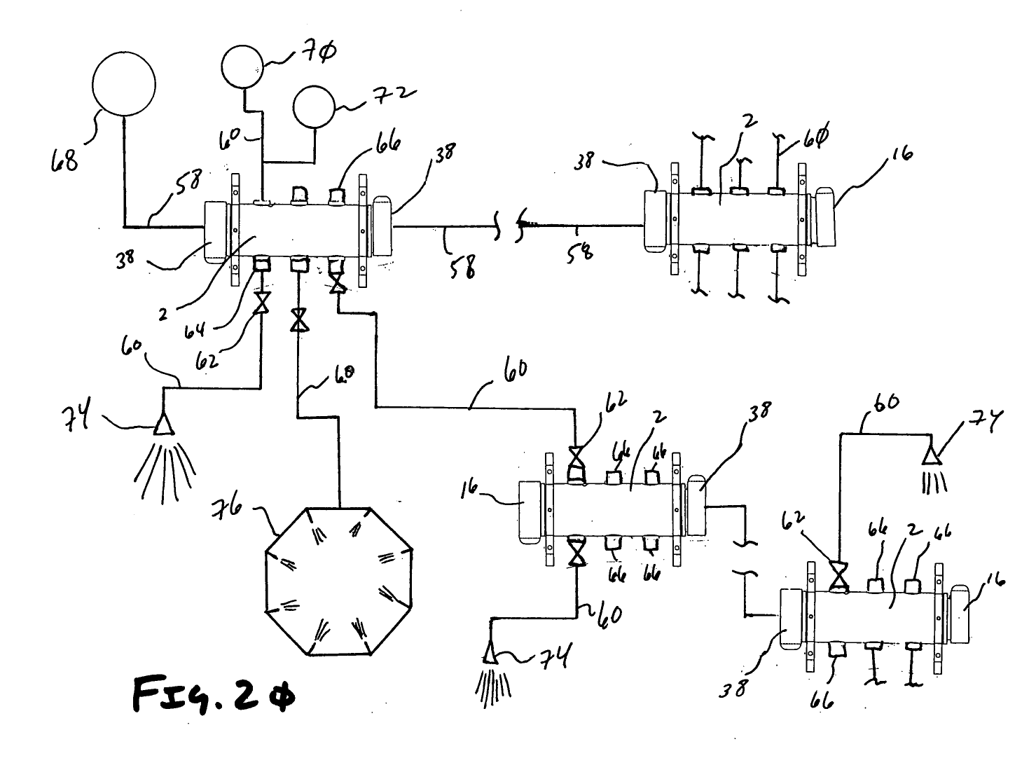

Referring now to FIG. 20, a method of interconnecting and utilizing a plurality of in-line manifolds 2 is shown. In one embodiment of the present invention, an in-line manifold 2 is interconnected to a fire hydrant 68 via a fire hose 58. From this manifold to a plurality of feed lines 60 or caps 66 may be interconnected. Here, a solution tank 70 is interconnected via feed line 60 to an outlet port of the in-line manifold 2, wherein a pump or similar device is used to direct the solution for treating of nuclear, biological, or chemical agents into the manifold 2. The feed lines 60 may be interconnected to various devices, such as showers 74 or shower hoops 76. The fluid flow to the treatment devices may be controlled by a valve 62, which may either alter the mass flow of the fluid exiting the manifold 2 or ensure that flow does not reenter the manifold 2 after it is exited, such as a check valve. Caps may be used to selectively close off outlets that are not to be used for the interconnection of a feed line 60. The feed lines 60 may interconnect to the inlets of the manifold 2 or alternatively to other outlets of the manifold 2 to supply fluids thereto. The manifolds 2 may be selectively capped 16 or may be opened such that they interconnect with additional manifolds 2 to supply a plurality of treatment devices. Preferably, the manifolds 2 are interconnected by a second fire hose that is interconnected to swivel connectors 38 of each manifold 2. One skilled in the art will appreciate that any possible interconnections via feed lines 60 or fire hoses 58 may be employed without departing from the scope of the invention. In addition, various types of hoses of any diameter or material may be used. For example, rubber, nylon, etc. may be utilized depending on the fluids being transported and the external conditions that the system is exposed to.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

1. A fluid intake/discharge manifold comprising:
a body, having a first end and a second end, said body having a internal diameter that defines a fluid flowpath;
an inlet interconnected to said first end of said body that is adapted to interconnect with a first fluid delivery device that transports fluid from a first location;
at least one outlet interconnected to said body between said first end and said second end that is adapted to selectively distribute the fluid to a second location via a second fluid delivery device; and
a discharge outlet interconnected to said second end of said body that is adapted either to interconnect with at least one of a cap, an adapter and a third fluid transportation device that transports the fluid to a third location.

2. The manifold of claim 1, wherein said first fluid delivery device is a standard fire hose of at least three inches in diameter and said second fluid delivery device is a hose of at least one inch diameter.

3. The manifold of claim 1, wherein said adapter is capable of swivelling interconnection with a standard fire hose.

4. The manifold of claim 1, wherein the body is constructed from at least one of steel, aluminum and plastic.

5. The manifold of claim 1, further including at least one of a valve or a nozzle interconnected to said at least one outlet.

6. The manifold of claim 1, further including a bracket and a clamp for interconnection thereto, said bracket and said clamp securing said body.

7. A fluid intake/discharge manifold comprising:
a body having a first end and a second end and an internal diameter that defines a path capable of carrying a flowing fluid;
a plurality of outlets interconnected to said body between said first and second ends;
an inlet interconnected to said first end of said body, which is adapted to operably interconnect with a hose; and
a discharge outlet interconnected to said second end of said body, which is adapted to interconnect with an adapter, wherein a second hose may be selectively interconnected to provide a fluid source for a subsequent manifold.

8. The manifold of claim 7, further comprising a flow control device, selectively interconnected to said plurality of outlets that may be selectively altered to dictate the fluid mass flow emanating from said manifold.

9. The manifold of claim 7, wherein said adapter is one of a cap, a swivel connector, or a reduce/expander.

10. The manifold of claim 9, wherein said swivel connector is adapted to interconnect to a standard fire hose.

11. The manifold of claim 7, wherein the body is constructed from at least one of steel, aluminum and plastic.

12. The manifold of claim 1, further including at least one of a valve or a nozzle interconnected to said at least one outlet.

13. The manifold of claim 1, further including a bracket and a clamp for interconnection thereto, said bracket and said clamp securing said body.

14. A method of delivering a fluid to a plurality of locations with a intake/discharge manifold comprising:
a) interconnecting an inlet hose, that is in hydraulic communication with a fluid supply, to an inlet of said manifold;
(b) interconnecting a plurality of hoses, which are of equal or smaller diameter of said inlet hose, to outlets of said manifold;
c) interconnecting said smaller hoses to treatment facilities, such as decontamination showers; and
d) interconnecting said manifold to a second manifold, such that said manifold and said second manifold are in hydraulic communication, and wherein additional treatment facilities may be accommodated.

15. The method of claim 14, wherein said fluid employs a counter-agent that aids in decontamination of nuclear, biological, or chemical agents.
